(19) United States
(12) Patent Application Publication
(10) Pub. No.: US 2026/0268659 A1
(43) Pub. Date: Sep. 10, 2026

(54) METHOD AND APPARATUS FOR RECOGNISING CONSTRUCTION PRODUCTS AND/OR PROCESSES AT A CONSTRUCTION SITE

(71) Applicant: Liebherr-Werk Biberach GmbH, Biberach an der Riss (DE)

(72) Inventor: Michael KREGER, Schemmerhofen (DE)

(21) Appl. No.: 19/657,962

(22) Filed: Apr. 24, 2026

Related U.S. Application Data
(63) Continuation of application No. PCT/EP2024/079665, filed on Oct. 21, 2024.

(30) Foreign Application Priority Data
Oct. 26, 2023 (DE) 102023129618.3

(51) Int. Cl. G06V 20/10; G06V 10/82

(52) U.S. Cl. CPC G06V 20/176; G06V 10/82

(57) ABSTRACT

The present invention relates to a method and an apparatus for recognizing construction products and/or construction processes at a construction site, wherein, by means of a sensor system, a construction product and/or process at the construction site is detected and a product- and/or process-specific sensor data record is provided which is evaluated by means of an artificial neural network to identify and/or characterize the construction product and/or process. It is proposed that the recognition of the construction products and/or processes is no longer carried out by a central artificial neural network and instead, for this, a plurality of separate artificial neural networks are used which have been trained differently from one another and only for different subsets of the construction products and/or construction processes provided at the construction site.

### CROSS-REFERENCE TO RELATED APPLICATIONS

This application is a continuation of International Patent Application Number PCT/EP2024/079665 filed Oct. 21, 2024, which claims priority to German Patent Application Number DE 10 2023 129 618.3 filed Oct. 26, 2023, both of which are incorporated herein by reference in their entireties.

### BACKGROUND

The present invention relates to a method and an apparatus for recognizing construction products and/or construction processes at a construction site, wherein, by means of a sensor system, a construction product and/or process at the construction site is detected and a product- and/or process-specific sensor data record is provided, which is evaluated by means of an artificial neural network to identify and/or to characterise the construction product and/or process. The invention further also relates to a construction machine having such an apparatus.

At construction sites, it is helpful for automated work sequences to automatically detect construction products, such as, for example, brick pallets, reinforcing irons, roof truss beams or building materials such as sand, gravel or cement, but also specific construction processes, such as an excavation of soil, concreting of a base slab or erection of formwork walls. The identifying of the respective construction product and/or process, or at least the characterising or typifying thereof, can be used, for example, to control automated work operations. For example, the identifying of construction objects located in the working area of a crane can be used to indicate to a crane, for an automated crane lift, whether and/or where in the working area of the crane a specific formwork element or formwork elements in general are present.

Alternatively or additionally, the automated identifying of construction objects and/or processes can also be used for monitoring the progress of the construction site, for example in order to verify, by comparison with data from a BIM, i.e. a so-called building information model, whether specific construction objects have already been installed or mounted at the correct position.

An approach known per se for object recognition uses artificial neural networks, which are sometimes abbreviated as ANN, and which are used for machine learning and artificial intelligence in order to interpret various data sources such as images, sounds, texts, tables, time series or also characteristic curves and to extract information or patterns, in order to apply these to unknown data and to make data-driven predictions or determinations. In order to be able to use such artificial neural networks successfully for detecting patterns in data, the artificial neural networks must regularly be trained beforehand with known data, the so-called training data, which the artificial neural networks use in order to learn and to improve their accuracy over time.

This training of the artificial neural networks is per se already very complex and requires a very large number of example data and very many varied training data in order to be able to recognize more complex patterns. At construction sites, this problem is further exacerbated, since a large variety of different construction products is present and many different construction processes are carried out. This diversity and quantity of construction products and construction processes at a construction site would require an unmanageable amount of training data in order to enable the artificial neural network, for example from the sensor data record, which is provided in the context of a crane lift by sensors such as cameras or laser detection sensors, to actually identify a respective construction product from the sensor data record. In any case, the diversity and quantity of training data would overwhelm a system provider and developer of a construction site detection and/or documentation system.

The patent document WO 2019/137815 A1, for example, proposes to detect building materials at a construction site for the purpose of data comparison with a BIM by means of a sensor system, wherein, in addition to material size and material property of the building material, which are detected, for example, by spectral sensors, also the shape of the construction product is detected by the sensor system, which is then analyzed by means of a machine vision algorithm in order to recognize the construction product. For this purpose, the algorithm was trained on the basis of a training data set formed from image data in order to generate characteristic features from the training images and to create a collection of feature vectors. In order to be able to assign a feature vector unambiguously to an object, a so-called classifier is trained.

For the reasons stated, such training regularly overwhelms a system provider of a system which captures and/or documents the entire construction site.

It is therefore the underlying object of the present invention to create improved methods and apparatuses of the type mentioned at the beginning, which avoid the disadvantages of the prior art and further develop the latter in an advantageous manner. n particular, a recognition system is to be provided, without overloading a system provider, which is able to reliably recognize construction products and/or construction processes at a construction site.

### SUMMARY

According to the invention, said task is solved by a method according to claim 1, an apparatus according to claim 10 and a construction machine according to claim 15. Preferred embodiments of the invention are the subject-matter of the dependent claims.

It is therefore proposed no longer to carry out the recognizing of the construction products and/or construction processes by a central artificial neural network, but instead to use a plurality of separate artificial neural networks, which are each trained only for sub-areas, but in comparison with one another for different sub-areas, of the construction products and/or construction processes possibly present at the construction site. According to the invention, the sensor data record, which is provided by the sensor system at the construction site during the detection of a construction product and/or a construction process and optionally pre-processed, is transmitted by the recognition system at the construction site to a plurality of separate artificial neural networks and is evaluated by the plurality of artificial neural networks to identify the construction product and/or construction process, wherein the results of the evaluations of the artificial neural networks are transmitted back to the recognition system at the construction site. By connecting a plurality of separate artificial neural networks, not only can overloading of the recognition system at the construction site due to excessively large data volumes or of a provider of the construction site recognition system due to excessive training effort for training a central artificial neural network be avoided, but also a relatively high spread of different identification probabilities and thereby a more reliable recognizing of the construction product and/or the respective construction process can be achieved.

Advantageously, the plurality of neural networks can be trained in a distinct manner from one another and each with only a subset or part of the construction products and/or construction processes that may be present at a construction site as a whole, and/or trained with training data sets which in each case describe or reflect only a portion of the total possible construction products and/or construction processes at a construction site, wherein different training data sets are used to train the algorithm for different artificial neural networks, so that each neural network is trained only with “its” construction products and/or construction processes.

In particular, the artificial neural networks can be trained in a manufacturer-specific or provider-specific manner only for the product range and/or process range of the respective manufacturer or provider of construction products, wherein such product- and/or process-range-specific training can be carried out, for example, in the sense of a deep-learning process, in which a large number of training data having high diversity can be supplied to the respective artificial neural network, wherein said training data in each case relate only to the construction products and/or construction processes which the respective manufacturer or provider has in its range.

The sensor data transmitted by the recognition system at the construction site to the different artificial neural networks, which are generated during the detection of a construction product and/or a construction process at the construction site by the sensor system and optionally pre-processed, can therefore be analyzed in a finer and more complex manner by the artificial neural network which has been intensively trained with the training data for the specific construction product or the specific construction process than by an artificial neural network which has been trained with training data relating to a completely different construction product.

If, for example, an image data set which represents a formwork element is transmitted as a query to an artificial neural network which has been trained with images relating to formwork elements, a high recognition probability can be expected. If, by contrast, the same image data set is transmitted as a request to an artificial neural network which has not been trained with images relating to formwork elements, but only with images relating to reinforcing irons and meshes, no high recognition probability can be expected, but rather a result such as, for example, “unknown” will presumably be returned.

In this respect, the results of the evaluations, transmitted back, when viewed in total, by the differently configured or differently trained artificial neural networks, can narrow down or identify the respective construction product with increased reliability, as the different evaluations can be assigned significantly different recognition probabilities.

Advantageously, the different artificial neural networks are not only trained individually and independently of the respective other artificial neural networks, but are also controlled autonomously and independently of the respective other artificial neural networks by operator or manufacturer. In particular, the manufacturers or providers of the respective construction products and construction processes retain full control over the data relating to their own construction products and construction processes, and in particular also over the training data by means of which the respective artificial neural network is trained. The manufacturer or operator of each artificial neural network can refuse access to its artificial neural network to any other manufacturer and/or operator of a respective other artificial neural network, and can also control and optionally block or deny the access which the recognition system of the construction site has.

For example, the communication between the recognition system of the construction site and the plurality of artificial neural networks can be controlled via an application programming interface API, wherein, by means of said application programming interface API, the respective manufacturer or operator of the artificial neural network can control access to its artificial neural network, in particular can block or deny the transmission of sensor data and/or the transmission back of analysis results, or can make this dependent on the successful passing of an access authorisation.

The recognition system at the construction site can select, from the plurality of results of the evaluations transmitted back by the different artificial neural networks, the best matching or most reliable result, for example on the basis of a probability of correspondence for a specific construction product and/or a specific construction process.

For this purpose, the recognition system at the construction site can, for example, take into account or evaluate or compare with one another evaluation characteristics transmitted together by the artificial neural networks, such as, for example, probabilities of correspondence.

Alternatively or additionally, the recognition system at the construction site can also use other supplementary information or compare the results of the evaluations with additional information beyond the responses of the artificial neural networks. For example, the recognition system can compare the results transmitted back with data from a construction site information model, i.e. a BIM, for example with regard to whether a construction product identified by an artificial neural network is present at the construction site at all or has already been delivered, in order, for example, to exclude such results or to classify them as less probable which, according to the information from the BIM, are not present at the construction site.

By using separate artificial neural networks, the evaluation time required for evaluating a sensor data record can also be significantly reduced, since the data volume, for example in terms of the number of feature vectors with which the sensor data are compared, is smaller per artificial neural network.

Alternatively or additionally to such a comparison with BIM data, the results transmitted back, which have been provided by the different artificial neural networks, can also be evaluated with one another or against one another. For example, the recognition system at the construction site can make majority decisions, for example to the effect that a specific construction product is regarded as identified if three out of five responses of the five artificial neural networks in this case have identified said construction product as such and two other responses represent deviations.

In an advantageous further development of the invention, the transmission of a sensor data record or of a request data record can also be controlled as a function of the presence of a specific assortment or a specific selection of construction products and their construction processes at the construction site. The assortment of construction products and/or construction processes currently present at the construction site can be determined, for example, by querying the BIM server or can be provided by the BIM, on the basis of which a preselection of the artificial neural networks is then made by the recognition system, to which the request data record is then actually transmitted.

Preferably, the selection of artificial neural networks to which a request is directed or to which a respective sensor data record is transmitted to identify is continuously or cyclically dynamically updated on the basis of information which is stored or maintained in the BIM with respect to the construction products and/or construction processes present at the construction site. By means of such a dynamic updating of the networks which can potentially be queried, the hit rate and reliability can be increased and at the same time the required evaluation performance and the data transmission volume and performance can be reduced.

Advantageously, said BIM can dynamically update the list of construction products and/or construction processes present at the construction site, preferably at relatively short intervals of at least once per week or once per day, so that the list of construction products or construction processes present at the construction site is preferably up to date on a daily basis. In particular, “old” construction products and/or construction processes which are no longer present at the construction site or have already been installed or completed are removed again from said dynamically updated list, so that this list actually contains only the currently present construction products and construction processes, whereby the selection of the artificial neural networks to be requested can be further restricted in a more specific manner in order to achieve further improved results.

If, for example, the BIM provides the information that currently only construction products of providers A, B and C and construction processes only of service provider D are present at the construction site, the recognition system can transmit a sensor data record or a request data record, which has been provided by the sensor system and optionally pre-processed, only to the artificial neural networks of the manufacturers A, B, C and of the service provider D, since their artificial neural networks have been specifically trained for the possible construction products and construction processes. Further artificial neural networks which are in principle available for requests, for example of further manufacturers E, F and G, can be excluded on the basis of said preselection.

Alternatively, however, also such presumably less qualified artificial neural networks of said manufacturers E, F and G can be requested, wherein, for example, a prior weighting can be generated and optionally stored, in particular to the effect that the results transmitted back by the artificial neural networks E, F and G will presumably have a lower hit probability, which can then be taken into account when selecting the applicable result by the recognition system.

The invention is explained in more detail below with reference to a preferred embodiment and the corresponding drawings. The drawings show:

### BRIEF DESCRIPTION OF THE DRAWINGS

The invention is explained in more detail below with reference to a preferred embodiment and the corresponding drawings. The drawings show:

FIG. 1: a schematic representation of an apparatus for recognizing construction products and/or construction processes at a construction site according to an advantageous embodiment of the invention, which illustrates the sensor system used at the construction site and the sensor data record provided thereby as well as the transmission of said sensor data record to different artificial neural networks.

### DETAILED DESCRIPTION

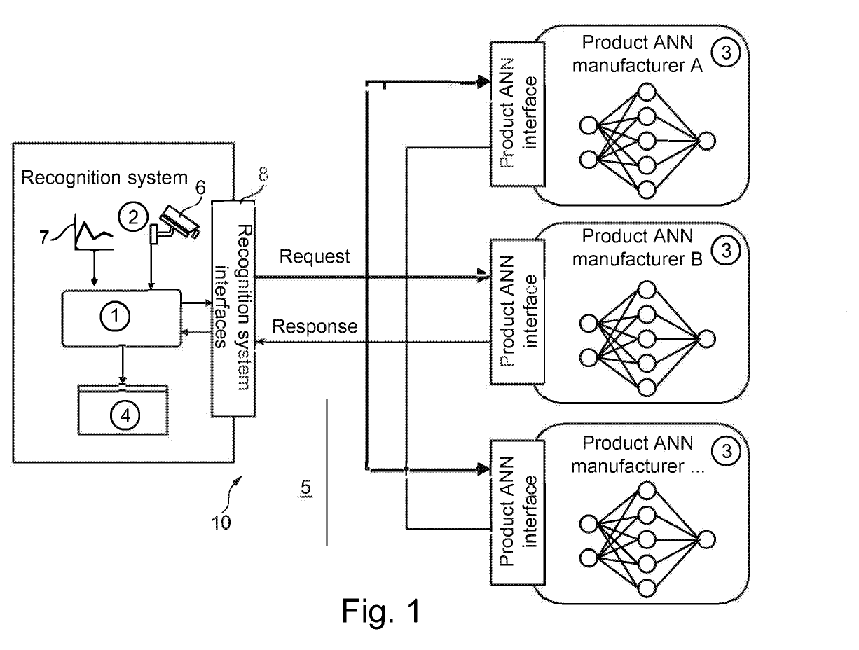

As shown in FIG. 1, the apparatus 10 for determining construction products and/or construction processes comprises a recognition system 1, which can be installed at a construction site 5 and can, for example, comprise a construction site server or be at least partially implemented therein. Alternatively, or additionally, the recognition system 1 can also be installed on a construction machine, such as, for example, a crane, by means of which construction products can be processed or transported at the construction site 5.

Said recognition system 1 can, for example, comprise, as an electronic component, a microprocessor, a program memory, a working memory and input/output units, for example comprising a data transmission module, in order to process sensor data and to communicate with artificial neural networks 3.

In particular, sensor data can be supplied to the recognition system 1 by a sensor system 2, which said sensor system 2 can provide during the detection of construction products and/or construction processes at the construction site 5.

In this respect said sensor system 2 can comprise various sensors or detectors, wherein in particular an image-detecting sensor system or imaging sensors can be provided, for example in the form of an image and/or video camera 6 and/or a LIDAR sensor system and/or a radar sensor system and/or a laser sensor system for scanning construction products by means of a laser beam and/or an infrared sensor system for generating an infrared image and/or an ultrasound sensor system for generating an ultrasound image of the construction products. Alternatively, or additionally, physical sensors 7 can also be used, the signals of which represent characteristic curves, cf. FIG. 1, wherein such sensors can comprise, for example, a spectral sensor system and/or a colour temperature sensor and/or a reflectance sensor system.

Preferably, said sensors of the sensor system 2 can operate without contact, wherein, however, contact sensors such as temperature sensors or pH value sensors can also be provided.

The sensor data provided to the recognition system 1 are combined by said recognition system 1 into a sensor data record or a request data record, optionally with a pre-processing of the received sensor data, such as, for example, signal filtering and/or signal amplification or other signal-conditioning measures. Said sensor data record is transmitted by the recognition system 1 via one or more data transmission interfaces 8 to different artificial neural networks 3A, 3B and 3N, wherein the transmission of the sensor data record to the different artificial neural networks can take place in parallel or simultaneously. For example, said transmission interface 8 can comprise a connection to a data network such as, for example, the Internet or also a radio network such as, for example, a mobile radio network, wherein said transmission interface 8 can be configured, for example, in the form of a WLAN interface or a radio module.

As shown in FIG. 1 shows, the plurality of different artificial neural networks 3 can each be trained for a manufacturer-specific construction product range. For example, the artificial neural network 3A of a construction product manufacturer can have been trained with training data which reflect or describe only the construction products which said manufacturer has in its product portfolio. Said training data can be sensor-detected image data of said construction products which the manufacturer distributes, or also sensor data detected by other sensors with respect to said construction products, wherein said artificial neural network, for example by means of a deep-learning method on the basis of said diverse and extensive training data, has recognized patterns in the sensor data, for example in the image data, which reflect said construction products. The data patterns or also the patterns in characteristic curves of physical sensors, with which the construction products have been detected during the training phase, can be used by the artificial neural network, for example, for generating algorithm rules, on the basis of which future sensor data records can then be analyzed or from which a respective construction product can then be identified.

The artificial neural network 3B of another manufacturer of construction products likewise shown in FIG. 1 has been trained in a similar manner, however with different training data, namely such training data which characterise or represent the specific construction product range of this further manufacturer, wherein this other construction product range can also have been detected by the sensor system, preferably by different sensor systems and in repeated detection cycles, in order to obtain a large and diverse quantity of training data for training the artificial neural network.

The same applies analogously to the further artificial neural network 3N, which may again have been trained in a similar manner, however again with other training data which represent or reflect the spectrum of construction products and/or construction processes which are offered by the manufacturer N.

The sensor data transmitted simultaneously by the recognition system 1 to the plurality of artificial neural networks 3, or the corresponding request data record, are then analyzed by the plurality of artificial neural networks 3 in order to perform an assignment to a construction product and/or to a construction process from the data patterns or characteristic curve patterns and to identify a corresponding construction product and/or a corresponding construction process, or at least to categorise or typify the same.

The results of the plurality of requested artificial neural networks 3 are then transmitted back by said artificial neural networks 3 to the recognition system 1, cf. FIG. 1.

The recognition system 1 determines, from the different responses of the different artificial neural networks 3, a specific construction product, for example on the basis of a probability of correspondence as described above, and provides the identification to a downstream application 4, for example a construction machine control device, for example in the form of a crane control, which can then, for example, perform an automated lifting operation in order to transport the identified construction product to the correct position at the construction site.

The recognition system 1 provided at the construction site 5 therefore no longer has to maintain all types of construction products and manufacturers thereof or all types of construction processes and service providers therefor, but is configured to integrate and/or to request different, in particular differently trained, artificial neural networks 3, in particular with a sensor data record or a request data record relating to construction products and/or construction processes which are also used at the construction site 5. As a result, load distribution and, in particular, a reduction of complexity in object and process recognition at the construction site 5 can be achieved.

With the proposed recognition system 1, in particular the manufacturers of construction products or the providers of construction processes can be incorporated into the detection process. Advantageously, said manufacturers or providers can each train their own autonomously operable artificial neural network only with their products, which leads to finer results not only due to the specific product selection but also due to the high level of product knowledge for the respective product range of the respective manufacturer.

In particular, the artificial neural networks remain with the respective manufacturer or provider, wherein the corresponding data can be stored, for example, in a manufacturer-specific or provider-specific cloud and can be used by the recognition system 1 of the construction site 5 only via an API, i.e. via a described interface or preferably even via a standardised interface in the future.

In principle, it is also conceivable that this network is also brought to the construction site 5, for example made usable via a data carrier or a computing unit on site. Independently thereof, however, the respective manufacturer of the construction products or provider of the construction processes retains data sovereignty over its artificial neural network 3 and the product information contained therein. In particular, said manufacturer or provider can update its artificial neural network at any time, in particular when new products or processes are added or previously offered products or processes are discontinued.

The recognition system 1 can provide the technological basis in order to address and request the distributed and mutually separate artificial neural networks, for example via sensor and/or image information. This can be carried out by the described detection sensor system 2 at the construction site 5, which enables observation of construction products and construction processes.

Said detection sensor system 2 or the recognition system 1 can, but does not have to, have its own knowledge base, since this can be distributed over the different artificial neural networks 3.

Which artificial neural networks 3 are requested in each case can be defined by the boundary conditions of the construction site 5, wherein this can be carried out, for example, by manual input, but in particular also automatically by the described digital building or construction site model BIM. In this case, the information from the BIM can be used, for example the information with regard to the manufacturers of materials and construction products used and/or with regard to the providers of the construction processes, in order to dynamically integrate the relevant artificial neural networks 3. This can advantageously be updated on a daily basis or at least at short intervals in combination with a construction schedule.

The evaluation, which can be carried out, for example, via weighting and probabilities from the results of the requested artificial neural networks 3 in accordance with the respective referenced source, can provide significantly improved recognition results.

A major advantage of the preferably daily updated integration of only relevant sources or artificial neural networks 3 is a significant increase in the overall probability in the sense of a true positive result, since potential sources of error, such as, for example, manufacturers which are not present at the construction site, can be excluded from the outset.

By means of the decentralised interaction or the use of external knowledge bases, in particular in the form of said artificial neural networks via an application programming interface, linked with a preferably cloud-based artificial neural network, a high-quality recognition system for construction products and construction processes at construction sites can be achieved.

We claim:

1. A method for recognizing construction products and/or construction processes at a construction site comprising:
detection by a sensor system of at least one construction product and/or process at a construction site, wherein the detection results in a sensor data record,
evaluating by an artificial neural network the sensor data record to determine the construction product and/or process;
transmitting the sensor data record from the construction site by a recognition system to a plurality of separate artificial neural networks;
evaluating by the plurality of separate artificial neural networks;
wherein the evaluating comprises identifying a construction product and/or construction process;
transmitting the results of the evaluations by the plurality of artificial neural networks back to the recognition system; and
recognizing the construction product and/or process, wherein the transmitting of the results is performed to recognize the construction product and/or process.

2. The method of claim 1, wherein the plurality of separate artificial neural networks are distinct from one another and are trained individually using different, network-specific training data.

3. The method of claim 2, wherein the plurality of separate artificial neural networks are each trained with training data that reflects only a subset of the construction products and/or construction processes overall used at the construction site, wherein the training data for the different artificial neural networks are generated using different ranges of construction products and/or different ranges of construction processes, such that each artificial neural network is trained with individual, network-specific training data.

4. The method of claim 1, wherein each of the plurality of separate artificial neural networks represents only the ranges of construction products and/or the ranges of construction processes of a provider of construction products and/or construction processes.

5. The method of claim 1, further comprising training and managing each of the plurality of separate artificial neural networks autonomously and independently of the other artificial neural networks, and blocking the training data and information data sets of each neural network from being accessed by the other artificial neural networks.

6. The method of claim 1, wherein the transmission of the sensor data record to a respective one of the plurality of separate artificial neural networks and/or the transmitting the result of the evaluation by a respective one of the plurality of separate artificial neural networks back to the recognition system is made dependent on approval by the respective one of the plurality of artificial neural networks or an access control apparatus cooperating therewith, and is blocked in the absence of such a consent.

7. The method of claim 1, wherein the transmitting the sensor data record from the recognition system to the plurality of separate artificial neural networks comprises transmitting via an application programming interface (API) and/or the transmission of the results of the evaluations from the plurality of artificial neural networks back to the recognition system via the API.

8. The method of claim 7, further comprising verifying access authorization of the recognition system to each of the plurality of separate artificial neural networks by the API, and wherein the access authorization to be verified by the API is individually predetermined by each of the plurality of separate artificial neural networks.

9. The method of claim 1, wherein, using at least one additional piece of information, from the results of the evaluations of the plurality of separate artificial neural networks transmitted back a respective construction product and/or a respective construction process is identified by the recognition system.

10. The method of claim 9, further comprising using a respective construction product and/or construction process by the detection system as additional information for the identification.

11. The method of claim 10, further comprising executing a comparison of the results obtained from the evaluations of the different artificial neural networks with additional information from a construction site information model (BIM) by the recognition system for the identification, wherein the executing of the comparison comprises determining whether a construction product identified in a respective result and/or a construction process identified in the result is present at a construction site on the basis of the information from the BIM.

12. The method of claim 1, further comprising comparing, by the recognition system, the results of the evaluations of the different artificial neural networks transmitted back with one another and determines a majority probability for a construction product and/or a construction process, wherein the comparing comprises identifying the construction product and/or construction process.

13. The method of claim 1, further comprising requesting a preselection of the artificial neural networks with the sensor data record, wherein the requesting is made by the recognition system for the transmission of the sensor data record using information from a BIM, and further comprising transmitting the sensor data record only to the artificial neural networks which are trained with the training data for construction products which are also present at a construction site on the basis of the information from the BIM.

14. The method of claim 13, further comprising transmitting the sensor data record only to the separate artificial neural networks which are trained with training data on construction products which are present at the construction site on the basis of the information from the BIM at the time at which the sensor data was detected by the sensor system at the construction site.

15. The method of claim 14, further comprising dynamically updating the selection of the artificial neural networks to which a sensor data record is to be transmitted, wherein the dynaically updating comprises using the information of the BIM.

16. The method of claim 15, further comprising dynamically updating the BIM with regard to the information as to which construction products are present at the construction site and/or which construction processes are executed at the construction site, and wherein the dynamic update is performed at least every working day; and
removing from the data record of the information construction products which were present at the construction site but are no longer present and/or such construction processes which were performed at a construction site but have been completed, wherein the removal is on the basis of which the artificial neural networks are selected for the transmission of the sensor data record.

17. An apparatus for determining construction products and/or processes at a construction site, comprising:
a sensor system for detecting at least one construction product and/or process at the construction site and providing a sensor data record resulting from the detection,
a recognition system configured to transmit said sensor data record from the construction site to a plurality of separate artificial neural networks for evaluation of the sensor data record and to receive from said artificial neural networks results of the individual evaluations of the artificial neural networks and to identify a respective construction product and/or a respective construction process from the results.

18. The apparatus of claim 17, wherein said recognition system is in communication connection with said plurality of separate artificial neural networks via one or more data transmission interfaces, wherein said artificial neural networks are trained distinct from one another and are individually trained with network-specific training data, each representing only a portion of the range of construction products and/or construction processes present at a construction site as a whole.

19. The apparatus of claim 18, wherein said data transmission interface is an API for controlling access of the recognition system to the artificial neural networks.

20. The apparatus of claims claim 19, wherein the sensor system comprises at least one optical and/or imaging sensor module for providing image data of the construction product detected and/or the construction process detected.

21. The apparatus of claim 20, wherein said optical and/or imaging sensor comprises a camera for providing a camera image of the construction product and/or the construction process, wherein the artificial neural networks are trained with training data describing the external appearance, in particular an outline contour and contour size of the respective construction products.

22. The apparatus of claim 17, wherein the sensor system comprises at least one physical sensor for providing a gait pattern describing a property of a detected construction product and/or construction process, wherein the artificial neural networks are trained with training data describing gait patterns of a physical detection and/or physical property of at least one construction product and/or construction process.

23. A construction machine comprising an apparatus configured according to claim 17.

24. The construction machine according to claim 23 configured as a crane.
